(19) United States
(12) Patent Application Publication
(10) Pub. No.: US 2007/0286466 A1
(43) Pub. Date: Dec. 13, 2007

(54) DICOM adapter service for CAD system

(76) Inventors: Patrick B. Heffernan, Campbell, CA (US); Daoxian H. Zhang, Los Gatos, CA (US)

Correspondence Address: PATENT LEGAL STAFF;EASTMAN KODAK COMPANY, 343 STATE STREET, ROCHESTER, NY, 14650-2201, US

(21) Appl. No.: 11/440,978

(22) Filed: May 25, 2006

(51) Int. Cl. G06K 9/00

(52) U.S. Cl. 382/128

(57) ABSTRACT

A system for processing medical data related to a patient. The system includes an algorithm server, an adapter service, and at least one storage device. The algorithm server accepts input medical data and processes the input medical data to form output medical data. The adapter service provides the input medical data for use by the algorithm server. The adapter service comprises: (1) a controller for managing adapter service interaction with the algorithm server; (2) at least one input module communicating with an input apparatus over a network connection for obtaining patient data from the apparatus, and conditioning the patient data to form the input medical data for the algorithm server; and (3) at least one output module accepting the output medical data from the algorithm server, and conditioning the output medical data according to a data interchange standard. The storage device stores the input medical data obtained by the adapter service.

### CROSS REFERENCE TO RELATED APPLICATIONS

Reference is made to commonly assigned application U.S. Ser. No. ______ (Kodak Docket No. 92189), entitled “DIGITAL MAMMOGRAPHY SYSTEM WITH IMPROVED WORKFLOW” by Zhang et al, filed on common date herewith, incorporated herein by reference.

Reference is made to commonly assigned application U.S. Ser. No. 11/284,570 (Kodak Docket No. 89138), entitled “COMPUTER AIDED DETECTION OF MICROCALCIFICATION CLUSTERS” by Zhang et al., filed on Nov. 22, 2005, based on Provisional Patent Application No. 60/631,154, filed on Jan. 4, 2005, incorporated herein by reference.

Reference is made to commonly assigned application U.S. Ser. No. 11/285,231 (Kodak Docket No. 89139), entitled “AUTOMATIC IMAGE CONTRAST IN COMPUTER-AIDED DIAGNOSIS” by Zhang et al., filed on Nov. 22, 2005, based on Provisional Patent Application No. 60/631,156, filed on Nov. 24, 2004, incorporated herein by reference.

### FIELD OF THE INVENTION

The present invention relates to handling of medical images and related patient data, and more particularly relates to an apparatus and methods for managing transfer, processing, and storage operations of patient data files.

### BACKGROUND OF THE INVENTION

The DICOM (Digital Imaging and Communications in Medicine) standard was developed to promote the manage of patient data that is available from a range of diagnostic and imaging systems. Developed and maintained as a joint effort through the National Electrical Manufacturers Association (NEMA), the DICOM data interchange standard has a goal of providing a common framework for acquisition, transmission, archival, retrieval, and presentation of medical images and related patient data from a variety of imaging modalities and environments.

Benefits from DICOM conformance include interoperability of equipment from different manufacturers so that patient data, once obtained, can be accessible for display, printing, diagnostic assessment, and storage, without requiring proprietary systems and software. For example, DICOM conformance allows mammography images from different types of equipment to be processed on a single Computer-Aided Diagnosis (CAD) system. Results from the CAD system can then be stored and used for viewing or presentation by other conforming systems.

The DICOM standard defines data structures, communication protocols, and interaction models for data transfer between systems. While it is widely viewed that DICOM conformance offers considerable benefit to equipment manufacturers and systems providers as well as to medical professionals and the patients they serve, achieving conformance and compatibility between systems has proven to be a challenge. Even though efforts at conformance have been underway, seamless interoperability is not guaranteed because different vendors can implement different parts of the same large standard.

In an effort to facilitate DICOM inter-operability, an ongoing industry initiative entitled Integrating the Healthcare Enterprise (IHE) was formed. The IHE effort has helped to delineate how portions of the DICOM standard can be implemented in practice, so that the necessary common framework for information interchange can be developed in a coordinated and timely manner.

FIG. 1 shows known components and workflow for a conventional CAD system 10 that employs proprietary and/or non-standard data formatting and interchange mechanisms. An image capture device 12, for example a film scanner, provides digital image data for a patient. For digital mammography systems, image capture device 12 is generally considered to be an FFDM (Full-Field Digital Mammography) system. The acquired data is typically queued for processing. An algorithm server 20 performs image processing for diagnostic assessment. Algorithm server 20 typically obtains and stores the resulting image data on a storage device 14 and also provides presentation data that can be viewed on a display 16, printed, transferred to a networked system, or written to an archival storage medium such as an optical disk. Log information is also maintained by algorithm server 20. The model of FIG. 1, used with existing CAD systems, may not readily interface with input or output equipment unless the equipment is provided by the same manufacturer or systems integrator.

There is particular interest in DICOM compliance from vendors who provide mammographic CAD systems. These systems accept digital image input data, typically scanned from X-ray films, and perform various algorithmic operations on the images obtained in order to help automate the identification of lesions and other structural abnormalities within the breast tissue. Some examples of mammography CAD systems are described in U.S. Pat. No. 5,729,620 (Wang) entitled “Computer-Aided Diagnosis System and Method”, and U.S. Pat. No. 6,650,766 (Roger) entitled “Method For Combining Automated Detections From Medical Images With Observed Detections Of A Human Interpreter”. It is preferred that DICOM compliance for CAD systems provide system compatibility, and support the overall CAD processing work flow.

In the proprietary model of FIG. 1, image data formats and attributes such as resolution, dynamic range, and other characteristics are known to the image analysis logic of algorithm server 20. However, in a typical global DICOM environment, the source of the image data is not as tightly controlled. Instead, as shown in the block diagram of FIG. 2, mammography image data that provides the input to algorithm server 20 in CAD system 10 can be obtained from a range of different sources, with multiple image capture devices 12. Images can be scanned from film in current environments, but are potentially generated from digital sources of various types, with the images varying in resolution, dynamic range, and other characteristics and accompanied by variable amounts of patient metadata. In general, the output from algorithm server 20 is made available for use by a PACS (Picture Archiving and Communications System). CAD system output is suitable for presentation, such as on a display 16 or in printed form from a printer 18 and can be stored on an external storage device 22 or medium for possible future use, but is adaptable for use on a range of different equipment. The model of FIGS. 1 and 2, without further interface utilities, can prove difficult to adapt to an open standards environment using equipment from other manufacturers, such as that envisioned in the DICOM model.

Some approaches for adapting CAD capabilities to the DICOM environment include interface solutions that are coupled to specific input and output devices and that function to convert data that is native to the device into suitable DICOM data objects.

For example, U.S. Pat. No. 6,909,795 (Tecotzky) entitled “Communicating Computer-Aided Detection Results in a Standards-Based Medical Imaging Environment” describes a method for CAD data transfer employing DICOM mechanisms and data objects. In this reference, an image acquisition system is coupled to an x-ray unit or other device that generates input image data of a particular “modality”, such as X-ray, mammography, or other type of patient image. The image acquisition utility then repackages the data to form an instance of an information object in accordance with DICOM standards, such as a Source Image Information Object Instance (SI-IOI). This data object is then available to the CAD algorithms that operate upon the image data to provide a CAD Structured Report Information Object Instance (SR-IOI).

Other proposed DICOM implementations are described in U.S. Patent Application Publication No. 2002/0146159 (Nolte) entitled “Method for Processing Objects of a Standardized Communication Protocol”, and U.S. Patent Application Publication No. 2003/0101291 (Mussack) entitled “Application Programming Interface for Provision of DICOM Services”.

While such proposed implementations intend to provide communication where there is conformance to DICOM interface standards, some practical problems remain. It is known to those familiar with the DICOM implementation effort and IHE initiatives, that DICOM conformance is not sufficient for interoperability, nor is full DICOM compliance likely for some time. Even with DICOM conformance for new products and systems, there would be legacy systems that may not be adaptable, or fully adaptable, to the new standards. Moreover, the ongoing work of DICOM committees suggests that there will be continuous improvement and, as a consequence, ongoing change. Thus, in practice, an environment is likely to include some proprietary systems as well as other systems and equipment that exhibit various levels of conformance to the DICOM standard. Accordingly, idealized system architecture implementations may not prove sufficient for the real world interchange of medical image data. The referenced implementations may not be readily usable with environments that have a range of different conformance levels.

U.S. Patent Application No. 2002/0124119 entitled “System and Method for Facilitating the Communication of Data on a Distributed Medical Scanner/Workstation Platform” (Bidarahalli) discloses software structure for interaction between a scanning workstation and various data storage devices or repositories in a networked system. Bidarahalli describes an Applications Program Interface (API) framework, using abstract data objects to facilitate communication between the workstation and external repository devices. However, it is not clear to Applicants how such a scheme would be implemented.

Accordingly, there exists a need for an apparatus and method that provides workflow management for providing patient image data to a CAD server and managing the storage and transmission of the CAD output data, compatible with a data interchange environment having at least partial conformance to the DICOM standard.

### SUMMARY OF THE INVENTION

Accordingly to one aspect of the present invention there is provided a system for processing medical data related to a patient. The system includes an algorithm server, an adapter service, and at least one storage device. The algorithm server is adapted to accept input medical data and process the input medical data to form output medical data. The adapter service is adapted to provide the input medical data for use by the algorithm server. The adapter service comprises: (1) a controller for managing adapter service interaction with the algorithm server; (2) at least one input module communicating with an input apparatus over a network connection for obtaining patient data from the apparatus, and conditioning the patient data to form the input medical data for the algorithm server; and (3) at least one output module accepting the output medical data from the algorithm server, and conditioning the output medical data according to a data interchange standard. The at least one storage device stores the input medical data obtained by the adapter service.

Accordingly to another aspect of the present invention, there is provided a method for processing medical data related to a patient. The method includes the steps of: communicating with an input apparatus over a network connection for obtaining patient data from the input apparatus; conditioning the patient data to form input medical data; providing the input medical data to an algorithm server; processing the input medical data at the algorithm server to form output medical data; conditioning the output medical data according to a data interchange standard to obtain standard-conformant output medical data; and transferring the standard-conformant output medical data to a peripheral apparatus.

The present invention provides an infrastructure for interaction between different systems in a communication standards environment. It helps to isolate the image processing functions of an algorithm server from file format conversion and interaction protocol between systems.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a block diagram of a CAD system according to a conventional model.

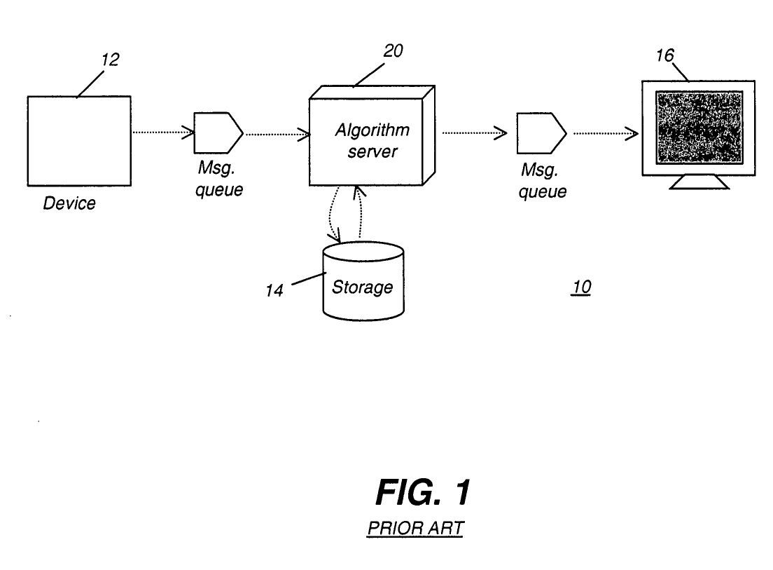

FIG. 2 is a block diagram of a CAD system having interfaces to multiple input and output peripherals, as anticipated in the DICOM model.

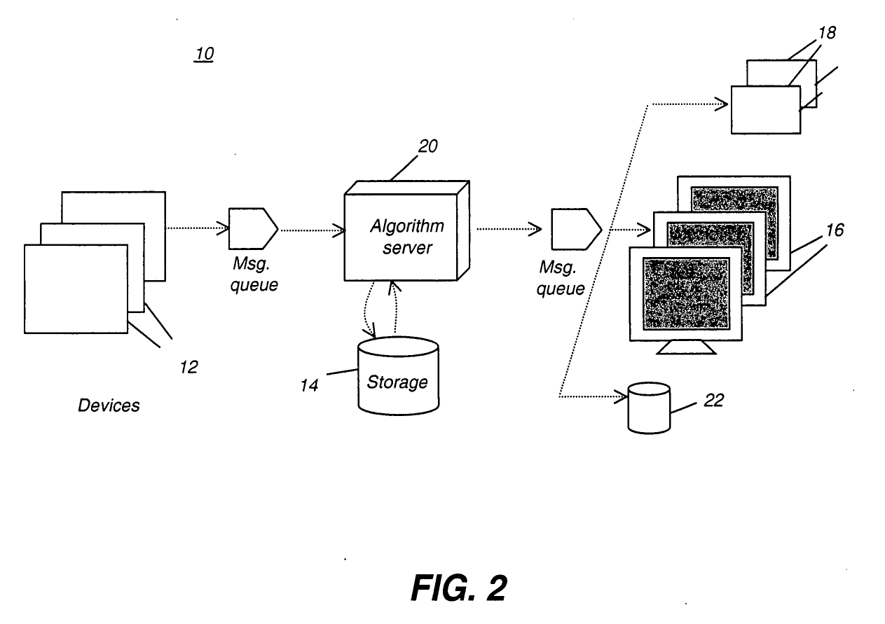

FIG. 3 is a block diagram of a CAD system having an adapter service according to the present invention.

FIG. 4 is a block diagram showing processes for handling image input from legacy systems in one embodiment.

FIG. 5 is a block diagram showing processes for handling image input data from DICOM-conforming systems in one embodiment.

FIG. 6 is a block diagram showing input processing for one embodiment.

FIG. 7 is a block diagram showing output processing by the adapter service of the present invention.

FIG. 8 is a block diagram showing the structure and operation of the adapter service of the present invention when interacting with proprietary and legacy DICOM systems.

FIG. 9 is a block diagram showing the structure and operation of the adapter service of the present invention when interacting with IHE Post-Processing Workflow (PWF) compliant systems.

FIG. 10 is a block diagram showing instances of key DICOM application entities used for legacy system interaction by a CAD processor according to one embodiment.

FIG. 11 is a diagram showing the time sequence of interactions for processing input images from a legacy DICOM system.

FIG. 12 is a plan view of a user interface window for adapter service configuration in one embodiment.

FIG. 13 is a plan view of a user interface window for adapter service configuration for each individual adapter module in one embodiment.

### DETAILED DESCRIPTION OF THE INVENTION

The following is a detailed description of the preferred embodiments of the invention, reference being made to the drawings in which the same reference numerals identify the same elements of structure in each of the several figures.

The present description is directed in particular to elements forming part of, or cooperating more directly with, the apparatus in accordance with the invention. It is to be understood that elements not specifically shown or described may take various forms well known to those skilled in the art.

The apparatus and method of the present invention can employ a DICOM communications network environment having various types of systems at different levels of conformance to the DICOM standard. To maintain communications and manage CAD workflow within such a system, an Adapter Service is provided. The Adapter Service isolates the CAD algorithm server from involvement with data protocols and interface handling and provides a configurable infrastructure for use with equipment and systems at various DICOM conformance levels. In this way, the Adapter Service acts as a type of gateway, data conditioner, and “traffic coordinator” that handles protocol transactions between systems and data transfer to and from storage and peripheral devices. A generic infrastructure allows the Adapter Service to be configured for both short-term legacy systems support of proprietary and legacy DICOM systems and longer-term IHE-compliant systems support, at varying levels of compliance.

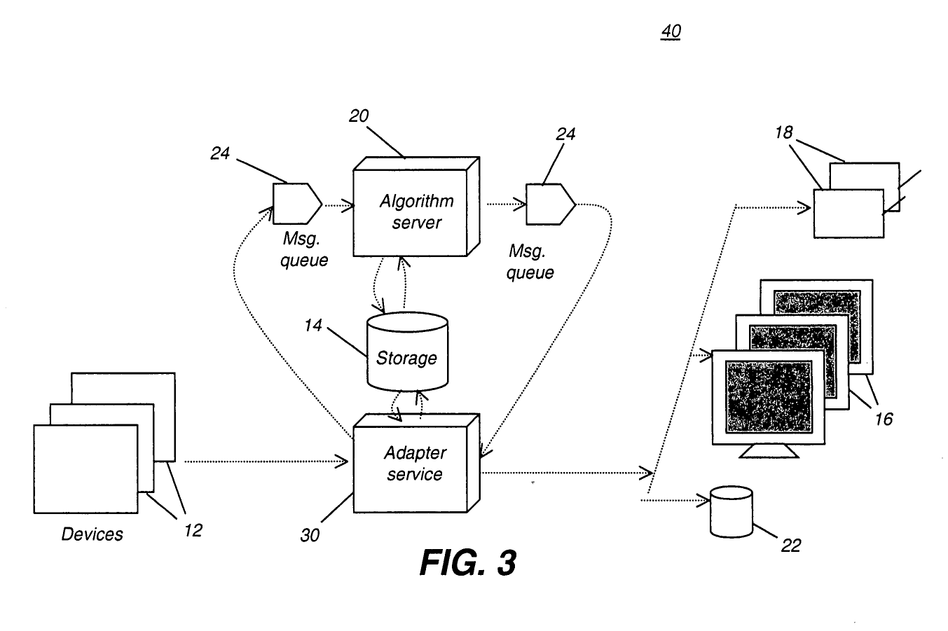

Referring to the block diagram of FIG. 3, there is shown a CAD apparatus 40 in which an adapter service 30 supports algorithm server 20. Adapter service 30 provides the means to obtain image data from multiple image capture devices 12 and to manage the workflow in which files are provided to, and received from, algorithm server 20. Adapter service 30 is configurable and can support multiple data interchange protocols, both for IHE-compliant DICOM interaction and for legacy system interface with input, output, and storage components.

Adapter service 30 can support a plurality of data sources as image capture devices 12 for obtaining patient data files, such as digitized mammography film, for example. Proprietary system image data may be provided as digitized data from film, in a particular file format, such as TIFF (Tagged Image File Format). To obtain the image data from the sending image capture device 12, adapter service 30 maintains a communication process with the sending system. In one embodiment, characteristic of proprietary system and legacy DICOM environments, image data files are automatically sent, or “pushed” to the network address of the adapter service 30 computer platform. In other embodiments, more characteristic of the IHE-compliant system, a general-purpose work-list service is used to coordinate file transfer, as described in more detail subsequently. Adapter service 30 utilizes storage device 14 of CAD apparatus 40 for storage of the received input image data.

When adapter service 30 has received and stored the input image data from image capture devices 12, it notifies algorithm server 20, for example, using a message queue 24. In one embodiment, message queue 24 is implemented using a Windows MSMQ (Microsoft Message Queue) message utility. Algorithm server 20 responds, in turn, by obtaining the image data from storage device 14 and operating upon the data to provide the necessary content for a structured report (SR) or other suitable data object containing the CAD contribution. Adapter service 30 is informed of status and progress, again using message queue 24. The generated content from CAD analysis is stored at storage device 14 and can be provided to the various output systems, as previously described.

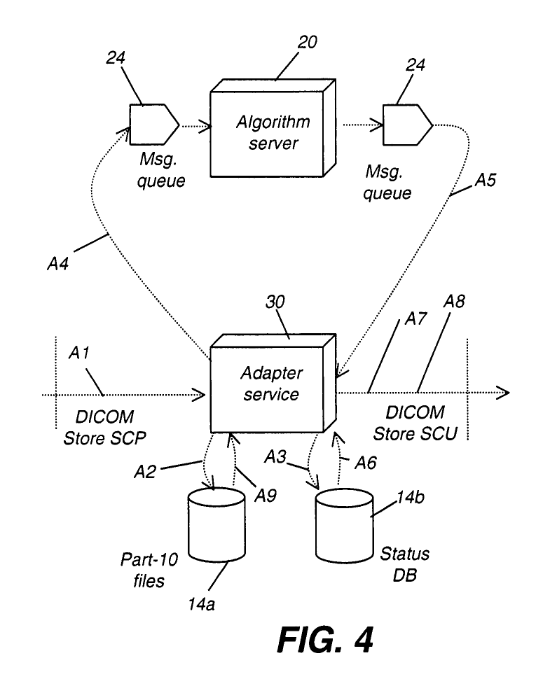

Workflow Interaction with Legacy Systems As described in the background section, some existing systems (termed proprietary or legacy DICOM systems in this disclosure) are not IHE-compliant, so that a particular site may have some mixture of non-compliant and partially compliant devices. The block diagram of FIG. 4 shows workflow steps by which adapter service 30 accepts and manages image data that is obtained from proprietary and legacy DICOM systems.

In this model, input image data is considered to be “pushed” to CAD apparatus 40, meaning that adapter service 30 is directly addressed by the sending image capture device 12 or other system. This data “push” model best suits earlier environments that may be partially DICOM-compliant and proprietary interfaces. Workflow steps themselves are shown with relation to the corresponding structures of CAD apparatus 40 to which they apply and are numbered with a preceding “A”.

In step A1, adapter service 30 receives data sent from image capture device 12 or other system acting as a data source. Adapter service 30 is configured to operate as a DICOM storage class provider. Storage requests for images of type MG (for mammography) are supported.

In step A2, images are received and stored to a storage device 14a in an appropriate format, such as DICOM Part-10 files (e.g., as described in Part 10 of the DICOM standard). These files are considered to be volatile, that is, for deletion once CAD processing is completed. Files for the same patient are associated together as a case.

In step A3, information about the case is stored in a local status database on a storage device 14b. This can be a procedure log, for example. Stored information can include a case identifier, various processing events, and location of the temporarily stored images.

In step A4, a job request is generated and sent to CAD input message queue 24. The job request includes the case identifier, type of file format (such as DICOM Part-10) and location of temporary source files and other information about the case. CAD processing is then initiated by algorithm server 20.

In step A5, at the completion of CAD processing at algorithm server 20, a Job Response message from algorithm server 20 is transmitted to adapter service 30. This includes job disposition (success/failure) and the case identifier.

In step A6, adapter service 30 uses the returned case identifier to retrieve case information stored in the status database of storage device 14b.

In step A7, instructions for output processing for images from the particular source are obtained and followed. Output conversion is performed, conditioning the resulting data from algorithm server 20, such as by conversion of saved DICOM Part-10 images and CAD reports (in XML format in one example embodiment). In one embodiment, output conversion provides DICOM structured reports, overlay planes, and secondary capture renditions, for example.

In step A8, the generated results for the case are sent to the appropriate data sinks for jobs from the data source. Transfer of this data is performed using a DICOM storage class, with adapter service 30 as a user.

In step A9, temporary data is cleaned up. This can employ a data cleanup service operating from the shared procedure log, for example. Storage devices 14a, 14b can be a single storage device, such as a hard disk drive, or can be separate devices, with either a local or a remote network connection.

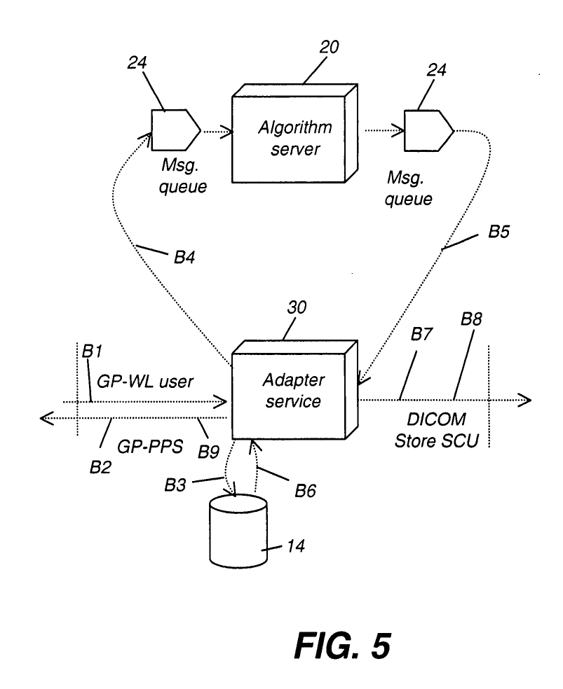

Workflow Interaction with IHE-conforming Systems The apparatus and methods of the present invention are designed for workflow interaction with both legacy DICOM systems, as was described with reference to FIG. 4, and with IHE-compliant systems. The block diagram of FIG. 5 shows workflow steps by which adapter service 30 accepts and manages image data that is obtained from DICOM-compliant systems that implement the IHE post-processing workflow (IHE PWF) model. In this model, an external worklist of post-processing tasks is generated by another networked system. Adapter service 30 queries this worklist to determine if there are patient cases to be processed, then obtains and routes the patient data accordingly. Workflow steps themselves are shown with relation to the corresponding structures of CAD apparatus 40 to which they apply and are numbered with a preceding “B”.

In step B1, adapter service 30 obtains information from the General-Purpose Work-List (GP-WL) generated externally from CAD apparatus 40. If there is an appropriate item in the list for mammography CAD processing, adapter service 30 claims that item.

In step B2, adapter service 30 sends a post-processing procedure step started message to the configured provider of the DICOM general-purpose performed procedure step service (GP-PPS). This initiates transfer of the patient information to CAD apparatus 40.

In step B3, adapter service 30 stores information on the case to be processed. This information is stored in a status database, here called the procedure log. The information stored in the procedure log includes identifying data about the case, such as its study and series UID according to the DICOM standard and can include information on various processing events and on how to locate the data.

In step B4, a CAD job request message is generated and sent to algorithm server 20 using the appropriate message queue 24. In the job request message, the data type is set to DICOM sorted, with information conveyed about how to retrieve the images, such as the identity of the archive and identifying data address. CAD processing is then initiated by algorithm server 20.

In step B5, at the completion of CAD processing at algorithm server 20, a Job Response message is sent through the appropriate message queue 24 from algorithm server 20. The Job Response message includes the job disposition (success/failure) and the case identifier.

In step B6, adapter service 30 uses the returned case identifier in order to retrieve case information from the local status database.

In step B7, instructions for output processing for images from the particular source are obtained and followed. Output conversion is performed, conditioning the resulting data from algorithm server 20, such as by such as conversion of saved DICOM Part-10 images and CAD reports (in XML format in one example embodiment). In one embodiment, output conversion provides DICOM structured reports, overlay planes, and secondary capture renditions, possibly also including the source data, for example.

In step B8, the generated results for the case are sent to the appropriate data sinks for jobs from the data source. Transfer of this data is performed using a DICOM storage class, with adapter service 30 as a user.

In step B9, a procedure step completed message is returned to the configured provider of the DICOM general-purpose performed procedure step service.

Input and Output Case Processing For mammography CAD and similar systems, multiple images from the same patient can be handled as a single case. This can apply if the originating system is a proprietary or legacy system or is DICOM-compliant.

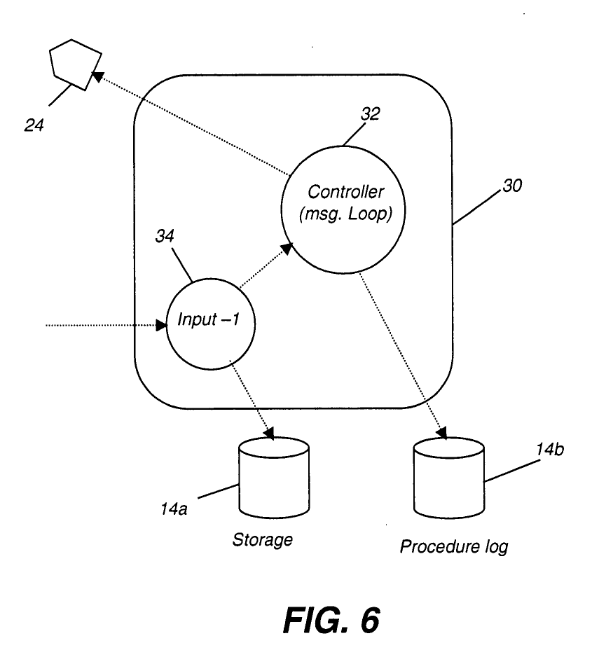

Referring to FIG. 6, there is shown, in summary form, the internal handling that is executed within adapter service 30 when input images are obtained for a patient. A controller 32 manages the input storage of patient images by an input adapter 34. Input adapter 34 directs the input image data to storage device 14a for temporary storage. Controller 32 maintains a procedure log, stored on storage device 14b. Storage devices 14a and 14b can be the same hardware component or separate components. Input adapter 34 can perform necessary data conversion, data formatting, or other conditioning of the image data, so that the image data is suitable to algorithm server 20 as input medical data.

It will be appreciated that the needed conditioning of the patient image data can vary depending on the image data source. Thus, a number of different input adapters 34 could be available within adapter service 30, each input adapter 34 performing a suitable conditioning operation on the input data from a particular type of networked input imaging apparatus. For example, an input imaging apparatus, such as a scanner from a particular manufacturer, may provide a patient image as grayscale data in a proprietary data representation format. Algorithm server 20 can process files that are in TIFF format. A specific input adapter 34 can then be provided for use with this particular interface. Adapter service 30 would then have several input adapters 34 available and would designate the appropriate input adapter 34 based on the input image type and source.

In the embodiment shown in FIG. 6, controller 32 communicates with the appropriate input adapter 34 for each incoming image. When the conversion, data formatting, or other data conditioning operation is reported to be complete, controller 32 then posts the incoming job in the message queue 24 for processing.

In the IHE-conforming environment, input adapter 34 is configured as a “listener”, listening for messages on a configured message queue that provides the worklist, as described above with reference to FIG. 5. In the proprietary or legacy DICOM environment, input adapter 34 accepts jobs being sent to the address of the adapter service 30 hardware. Case information that may be temporarily stored for the image data includes patient metadata to be used as input for DICOM output object generation. For mammography data, the data objects are of DICOM type MG.

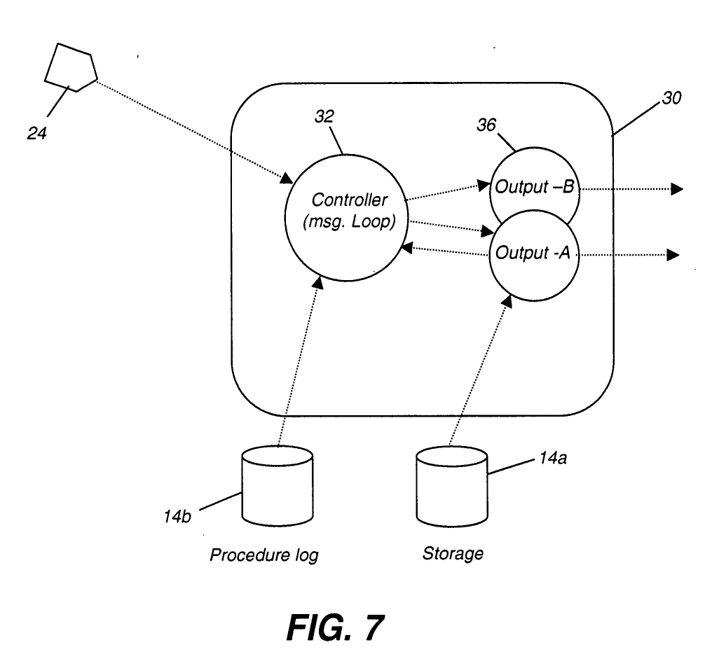

FIG. 7 shows the interaction of controller 32 with one or more modular output adapters 36 to provide the output DICOM structured reports to viewing workstations and other presentation, storage, and analysis systems. Similar to the situation with input sources, some conditioning of the output medical data from algorithm server 20 may be needed, so that this output data is usable by another system. For example, a legacy display apparatus might require image data in a bit-mapped format, so that conversion of output data from algorithm server 20 must be performed according to a proprietary data interchange standard when using this type of display apparatus. A DICOM IHE-compliant display device, on the other hand, may require that the image data be provided using an IHE-compliant data interchange standard. Compliance with a particular data interchange standard can include not only the format or representation of the data itself, but may also include the protocol used to transmit the data. Thus, for example, a particular output adapter may condition the format of the medical output data and also package and transmit the data using a suitable network protocol, depending on the destination device. When it receives a message that CAD output processing and conversion for the case is completed, controller 32 then updates the procedure log. Controller 32 provides each output adapter 36 with the needed case information, image data, reports, and references for generating the DICOM-compliant output.

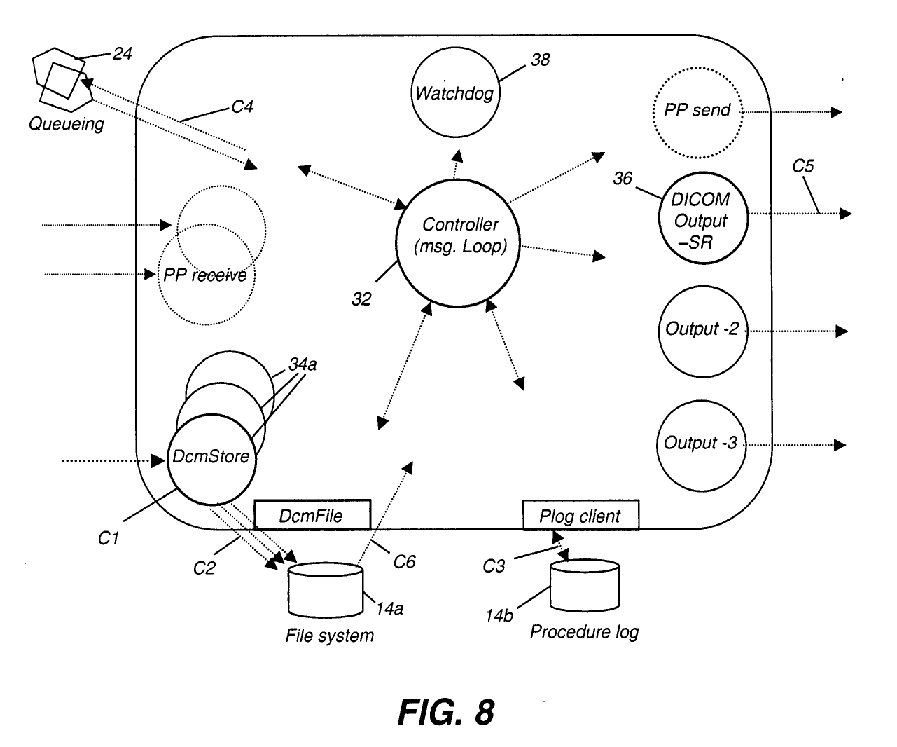

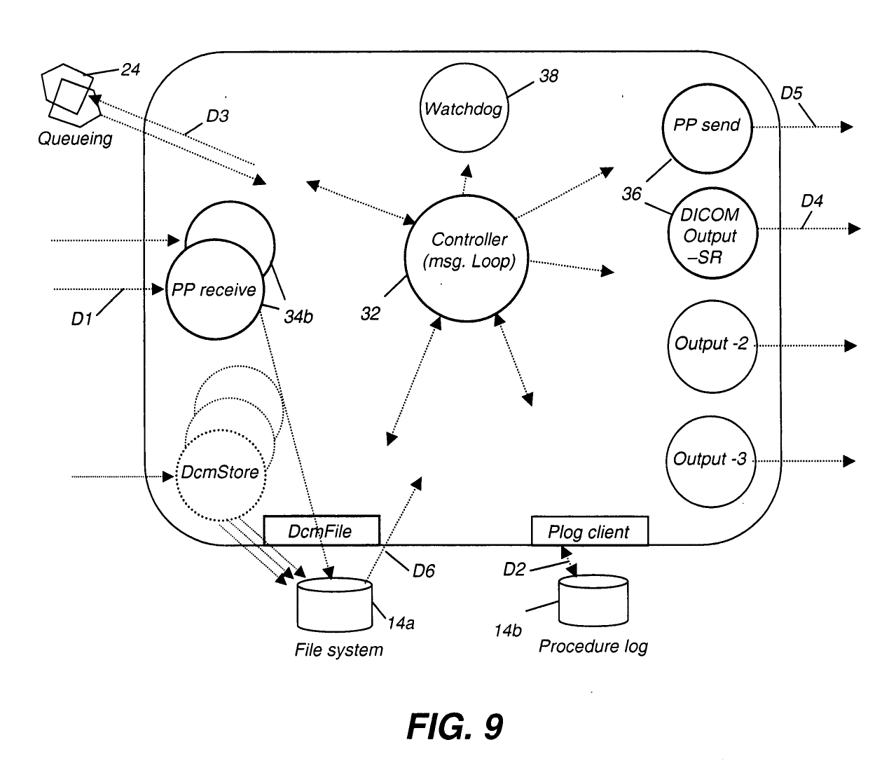

Structure of Adapter Service 30 FIGS. 8 and 9 show the internal structure of adapter service 30 in one embodiment. This structure enables adapter service 30 to handle proprietary and legacy transactions as well as DICOM transactions at various levels of conformance. Both FIGS. 8 and 9 show the same overall structures, with FIG. 8 highlighting those elements used for handling proprietary and legacy DICOM data transactions and FIG. 9 highlighting elements used for IHE PWF-conforming data transactions.

Referring to FIG. 8, interaction with legacy systems is shown. Processing steps are shown with relation to their corresponding structures of adapter service 30 and are numbered with a preceding “C”.

In an initialization step C1, a number of instances of input adapters 34a, labeled as DcmStore functions, are created. Input adapter 34a is a software module configured to accept image data for a patient that is transmitted from an external device. For example, each input adapter 34a can be assigned a port number in a TCP/IP network environment.

When input data is received, step C2 is executed, in which input adapter 34a stores the images for the case. Typically, images are stored in DICOM Part-10 file format. In step C3, information about the case is stored in a procedure log.

In step C4, controller 32 submits the case to input message queue 24 for processing by algorithm server 20 (FIGS. 3, 4). When processing completes, a completion message is received.

In step C5, the result of the processing is sent using the appropriate output adapter 36. Each output adapter 36 is a software module that conditions the data it receives as input to provide output data in the proper format. In the example of FIG. 8, the output adapter used provides a DICOM Structured Report (SR) for mammography CAD.

In step C6, configuration information for adapter service 30 is obtained from an application configuration file and from referenced configuration files, as needed.

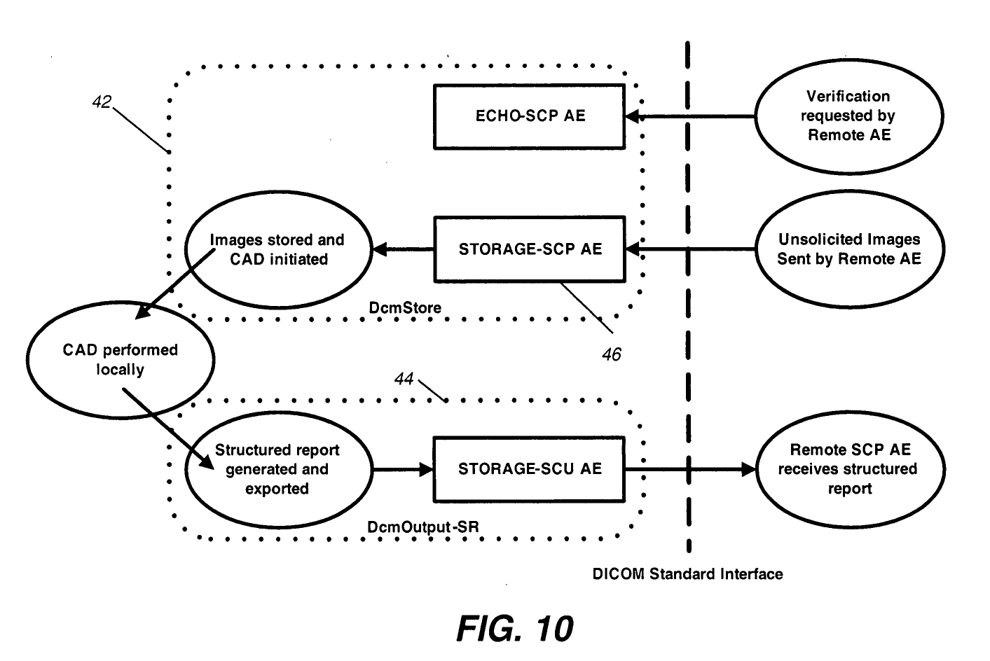

FIG. 10 shows the interaction of DcmStore and DcmOutput-SR instances in legacy “push” transactions over the DICOM standard interface of adapter service 30 with a Service Class Provider (SCP) in one exemplary embodiment. Here a DcmStore instance 42 receives unsolicited image data from a remote Application Entity (AE). A storage function 46 stores the received image data, as noted earlier. Following CAD processing, a DcmOutput-SR instance 44 generates the DICOM structured report for transmission and storage.

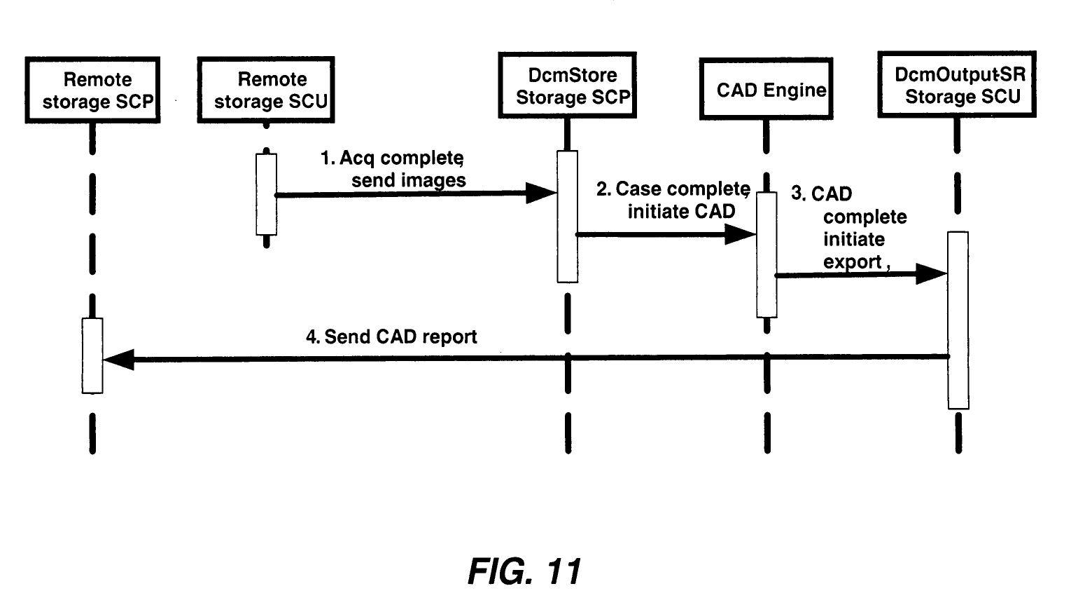

FIG. 11 shows the sequence of actions that support this processing, from left to right, where the output structured report is directed to a remote storage SCP (Service Class Provider).

Referring now to FIG. 9, this figure shows the interaction using the Post Processing Workflow (PWF) of IHE/DICOM-compliant systems. Processing steps are shown with relation to their corresponding structures of adapter service 30 and are numbered with a preceding “D”.

In step D1, a plurality of modular input adapters 34b are created. In one embodiment, these are Performed Procedure receive entities, conforming with the DICOM model. Each input adapter 34b is configured to monitor a post-processing general procedure work-list provider and to claim appropriate entries in the worklist as these appear. When input adapter 34b begins to transfer patient image data, it notifies the remote system that is configured to act as the performed procedure step manager using a performed procedure step started message.

In step D2, information about the case is stored, and can subsequently be retrieved, using the procedure log.

In step D3, controller 32 submits the case to input message queue 24 for processing by algorithm server 20 (FIGS. 3 and 5). When processing completes, a completion message is received.

In step D4, the result of the processing is conditioned, such as by format conversion or by some type of data structuring, and sent using the appropriate output adapter 36. In the example of FIG. 9, one output adapter 36 provides a DICOM Structured Report (SR) for mammography CAD.

In step D5, an output adapter 36 sends a DICOM performed procedure step completed message to the configured performed procedure step manager (a remote system).

In step D6, configuration information for adapter service 30 is obtained from an application configuration file and from referenced configuration files, as needed.

For the procedures described with reference to FIGS. 8 and 9, controller 32, in coordination with a watchdog function 38, monitors and coordinates the operation of input and output adapters 34a, 34b and 36, the handling of message queue 24, and storage at storage devices 14a, 14b.

The resultant output data from algorithm server 20 can be combined with other provided data, such as patient metadata obtained from the networked system that originated the image data or from some other system. The structured report that is formed conforms to the DICOM standard, even where conversion of data formats is needed. For example, in one embodiment, XML data generated from algorithm server 20 is converted to some other data format by adapter service 30. In the embodiments of FIGS. 8 and 9, this type of conversion is performed by an output adapter 36.

Configuration of Adapter Service 30 As is shown in FIGS. 8 and 9, adapter service 30 can be configured to use different types of input adapters 34a, 34b, and output adapters 36. From this perspective, adapter service 30 acts as the host for a variable set of data format converters or adapters. In contrast with conventional solutions that address data interaction in environments where different systems conform to an established standard, adapter service 30 is configurable. This configurability allows adapter service 30 to be flexibly adapted for interaction with different systems having various levels of DICOM conformance, from non-conforming legacy systems to fully conforming systems. This design strategy isolates the task of file conversion and data format conformance to adapter service 30, thereby freeing algorithm server 20 from this type of function. It will be appreciated that the modular approach allows adapter service 30 to interact with systems having a range of standards-conformance levels. Moreover, as standards are revised and improved, modular input adapters 34a, 34b, and output adapters 36 can be written for conforming systems and uploaded to adapter service 30 as updates, thus minimizing redesign time and cost. The set of modular input and output adapters 34a, 34b, and 36 can be continually expanding and can be usable by adapter service 30, without the need for modifications to the basic infrastructure.

In one embodiment, adapter service 30 is implemented as a Windows service in Microsoft Windows™. As such, adapter service 30 is configured to start up on system start, with no need for a user to be logged in. The service control manager can be set to restart adapter service 30 on failure. In this model, adapter service 30 is always running and available to process DICOM requests. Adapter service 30 can be provided as part of the same workstation that executes algorithm server 20 or provided on a separate hardware platform.

As appreciated from the description related to FIGS. 6, 8, and 9, adapter service 30 can have a plurality of DICOM inputs. This can be from multiple storage providers, for example and may be a “listener” of multiple work-list providers. Adapter service 30 receives input from algorithm server 20, such as responses to previous CAD requests. These inputs can occur simultaneously (conceptually), with the server thus needing to multiplex input on TCP/IP connections and message queues. There can be output operations occurring, for example, conversion and sending of CAD reports in different formats. It may be preferable that adapter service 30 perform these operations in parallel.

An additional input type for adapter service 30 relates to messages from the service control manager (SCM). Standard SCM messages include the ability to start, stop, pause, and resume a service, and also a means for conveying other signals to a service. These messages need to be handled safely with other input messages.

In one embodiment, each input or output adapter 34, 36 runs on a separate thread. Interfaces between the converters and the main control loop are constrained to a small set of methods, with those appropriately serialized in the main loop, so that the activities of the various adapters are handled in a thread-safe manner. A feature to facilitate this is the abstraction of a “controller” class, which embeds the logic for coordinating the requests from multiple sources. Adapters (and other input sources) communicate using a small number of public interfaces. Each interface generates a message that is placed on an internal queue within controller 32, and indicates to the main loop to “wake up” and process. On return from its blocking wait, the main loop checks the internal queue, and if there are messages there, it processes those. This provides a means for adapters and other external sources such as messages from the algorithm server and from the SCM to be handled reliably.

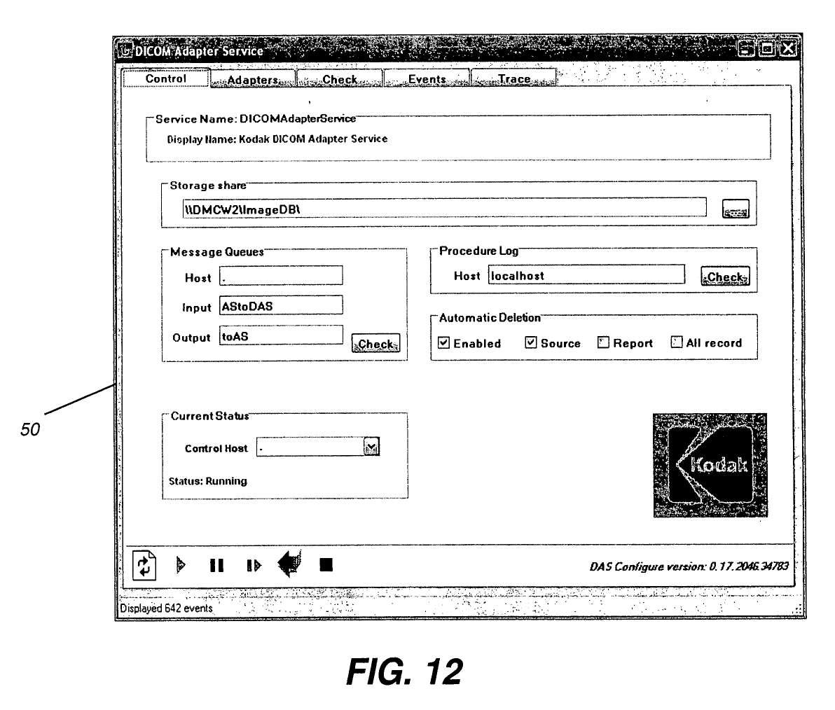

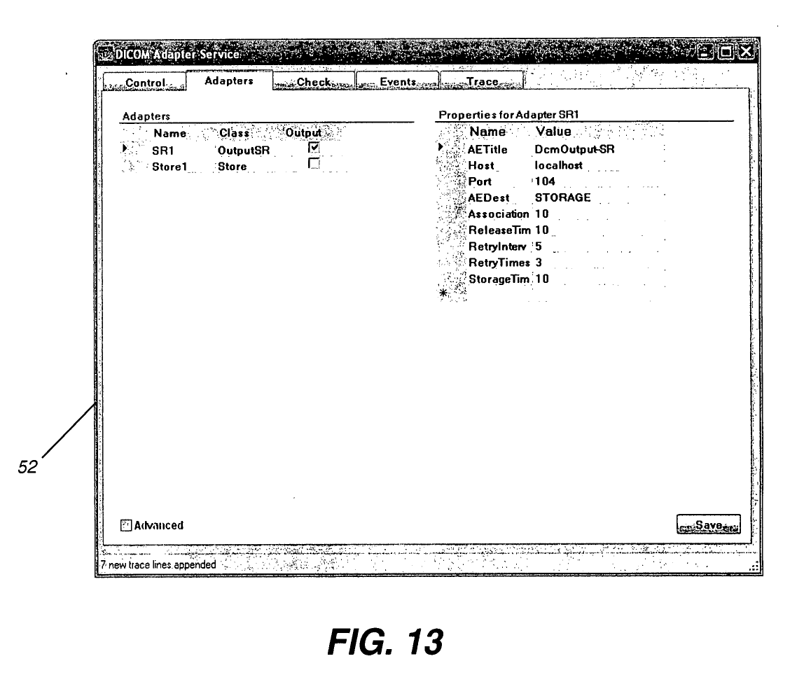

In one embodiment, adapter service 30 is provided with a configuration utility that allows adapter service 30 to be properly set up at each site. This tool is for systems integration personnel rather than for the end user. FIGS. 12 and 13 show sample user interface windows used for this function. A main configuration window 50, as shown in FIG. 12, allows capabilities such as assignment of a storage share area, input and output message queue setup, procedure log setup, disposition of received image files following processing, and shows current status for adapter service 30.

An adapter setup window 52, such as shown in FIG. 13, enables the setup of each input or output adapter. Parameters such as Application Entity title, hostname and port number, and retry attempts can be configured using this window. Other configuration utilities enable troubleshooting of network connections, viewing of a status log, and setting of various other parameters for adapter service 30 operation.

Accordingly, a system has been described for processing medical data related to a patient has algorithm server 20 for processing input medical data to form output medical data. Adapter service 30 provides the input medical data for use by algorithm server 20. Adapter service 30 has controller 32 for managing interaction with algorithm server 20 and input module 34a configured to communicate with an input apparatus over a network connection for obtaining patient data from the apparatus. Input module 34a conditions the patient data to form the input medical data for algorithm server 20. Adapter service 30 has output module 36 for accepting the output medical data from algorithm server 20 and conditioning the output medical data according to a data interchange standard. Storage device 14 stores the input medical data obtained by the adapter service.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, adapter service 30 can be implemented in a variety of different ways on a number of different types of computer workstation platform or dedicated logic processors. Various arrangements are possible for transfer and storage of received and processed patient data. Various networking schemes could be used.

While the systems solution of the present invention would be particularly well suited for providing DICOM interchange standard interaction support for a CAD mammography system, this same solution can be used more generally for the support of other types of systems that obtain and process medical data of various types as well as patient images. The solution of the present invention has particular value for systems that obtain data in one format, process that data according to a set of algorithms, and provide modified output data for use by other systems. While the description focuses on the solution of problems for DICOM interaction, these same solutions can be applied more generally to network environments where system interaction is standards-driven.

Thus, what is provided is an apparatus and method for managing transfer, manipulation, and storage operations on patient data files in a DICOM standards environment.

### PARTS LIST

10. CAD system
12. Image Capture Device
14, 14a, 14b. Storage device
16. Display
18. Printer
20. Algorithm Server
22. Storage Device
24. Message Queue
30. Adapter Service
32. Controller
34, 34a, 34b. Input adapter
36. Output Adapter
38. Watchdog Function
40. CAD apparatus
42. DcmStore instance
44. DcmOutput-SR instance
46. Storage Function
50. Main Configuration Window
52. Adapters Setup Window
A1-A9. Step
B1-B9. Step

1. A system for processing medical data related to a patient, comprising:
an algorithm server adapted to accept input medical data and process the input medical data to form output medical data;
an adapter service adapted to provide the input medical data for use by the algorithm server, the adapter service comprising:
(1) a controller for managing adapter service interaction with the algorithm server;
(2) at least one input module communicating with an input apparatus over a network connection for obtaining patient data from the apparatus, and conditioning the patient data to form the input medical data for the algorithm server; and
(3) at least one output module accepting the output medical data from the algorithm server, and conditioning the output medical data according to a data interchange standard; and
at least one storage device for storing the input medical data obtained by the adapter service.

2. The system of claim 1 wherein the medical data comprises mammography image data.

3. The system of claim 1 wherein the data interchange standard is DICOM.

4. The system of claim 1 wherein the adapter service employs a message queue to interact with the algorithm server.

5. The system of claim 1 wherein the at least one input module employs a worklist to obtains the patient data.

6. The system of claim 1 further comprising a display device for display of the conditioned output medical data.

7. The system of claim 1 wherein the adapter service comprises a plurality of input modules.

8. The system of claim 7 wherein the plurality of input modules comprises at least one input module for DICOM-conformant communication and at least one input module for communication that is not DICOM-conformant.

9. The system of claim 1 wherein the controller maintains a procedure log.

10. The system of claim 1 wherein the adapter service comprises a plurality of output modules.

11. A method for processing medical data related to a patient, the method comprising the steps of:
communicating with an input apparatus over a network connection for obtaining patient data from the input apparatus;
conditioning the patient data to form input medical data;
providing the input medical data to an algorithm server;
processing the input medical data at the algorithm server to form output medical data;
conditioning the output medical data according to a data interchange standard to obtain standard-conformant output medical data; and
transferring the standard-conformant output medical data to a peripheral apparatus.

12. The method of claim 11 further comprising the step of displaying the standard-conformant output medical data on a display.

13. The method of claim 11 further comprising the step of directing the standard-conformant output medical data to a printer.

14. The method of claim 11 wherein the patient data comprises a mammography image.

15. The method of claim 11 further comprising the step of storing the standard-conformant output medical data.

16. The method of claim 11 further comprising the step of maintaining a log for recording processing events.
